(19) United States
(12) Patent Application Publication
(10) Pub. No.: US 2022/0225611 A1
(43) Pub. Date: Jul. 21, 2022

(54) NON-NATURAL INSECT PHEROMONE BLEND COMPOSITIONS

(71) Applicants: Chris WHEELER, Santa Monica, CA (US); Provivi, Inc., Santa Monica, CA (US)

(72) Inventor: Chris Wheeler, Santa Monica, CA (US)

(21) Appl. No.: 17/616,633

(22) PCT Filed: Jun. 3, 2020
(86) PCT No.: PCT/US2020/035989

§ 371 Date: Dec. 3, 2021

Related U.S. Application Data
(60) Provisional application No. 62/857,133, filed on Jun. 4, 2019.

(51) Int. Cl. A01N 31/02; A01N 25/06; A01P 19/00; A01M 1/20; A01M 1/02; A01M 1/10

(52) U.S. Cl. CPC A01N 31/02; A01N 25/06; A01M 1/106; A01M 1/2016; A01M 1/02; A01P 19/00

(57) ABSTRACT

This disclosure concerns insect pheromone blend compositions comprising pheromones particular to reproductively isolated insects. In some aspects, the disclosure concerns non-natural insect pheromone blend compositions containing (Z)-13-Octadecenal or (Z)-9-Octadecenal that are surprisingly effective for the purpose of modifying the behavior of yellow stem borer (Scirpophaga incertulas) and/or striped stem borer (Chilo suppressalis) insect pests.

### CROSS-REFERENCE TO RELATED APPLICATIONS

This application is a national phase entry under 35 U.S.C. § 371 of International Patent Application PCT/US2020/035989, filed Jun. 3, 2020, designating the United States of America and published in English as International Patent Publication WO2020/0247542 A1 on Dec. 10, 2020, which claims the benefit of U.S. patent application Ser. No. 62/857,133, filed Jun. 4, 2019, the disclosure of which is hereby incorporated herein in its entirety by this reference.

### TECHNICAL FIELD

The present disclosure relates to insect pheromone compositions. Embodiments relate to mixtures of pheromone compositions that are surprisingly effective for singularly modifying the behavior of multiple, reproductively isolated insects. For example, particular compositions herein disrupt mating behavior in both yellow stem borer (Scirpophaga incertulas) and striped stem borer (Chilo suppressalis). Certain compositions herein further exhibit synergistic behavioral modification activity.

### BACKGROUND

Rice stem borer (i.e., Scirpophaga incertulas, or Yellow Stem Borer (YSB)) and striped stem borer (i.e Chilo suppressalis, or Striped Stem Borer (SSB)) are primary pests of concern in rice cultivation. Larval feeding damage may cause death of the rice central leaf whorl at the vegetative stage, a condition known as “dead heart.” Furthermore, damage at the reproductive stage may cause death of the emerging panicle, a condition known as “whitehead.” Stem borer rice yield losses are a result of panicle density reduction. Rice plants compensate for dead heart damage by the production of additional tillers, suffering serious yield losses due to compensatory tillers bearing smaller or lighter panicles. Panicle density can also be reduced in the case of whitehead damage. Heavy damage can reduce crop yields by as much as 29%.

Generally, farmers control rice stem borer pests using non-natural, synthetic insecticides. Lepidopteran insects are predominantly controlled by pyrethroid, organophosphate, and carbamate insecticide sprays. Organophosphates and carbamates have demonstrated carcinogenic and neurotoxic effects in humans, while pyrethroids and organophosphates may unintentionally harm beneficial insects or sensitive vertebrates like amphibians and fish. Such insecticides are considered to be a quick, easy, and inexpensive solution for controlling insects. However, using inappropriate insecticides can cause insecticide resistance and resurgence. Metcalf, R. L., (1982) In: Introduction to Insect Pest Management. 2nd edition, Metcalf & Luckmann, Eds., New York: John Wiley & Sons. pp 217-277. Insecticides may also cause significant risks to humans, the environment, and to non-target organisms such as beneficial soil microorganisms, insects, plants, fish, and birds, which leads to an outbreak of secondary pests, such as mites, and brown plant and green leaf hoppers. Aktar et al. (2009) Interdiscip. Toxicol. 2(1):1-12; Su et al. (2014) J. Econ Entomol. 107(1):333-41.

Pheromones are chemicals produced by an insect to communicate in some way with others of the same species. Currently, pheromones unique to a particular insect are being investigated for their potential in trapping and/or reducing the reproduction of the insect, for example, so as to reduce the size of the population to acceptable levels in vulnerable crops. Mating disruption involves the use of sex pheromones to prevent male insects finding females and mating. A pheromone chemical compound's mode of action is specific, so that it is safe to humans and other beneficial organisms. In any case, workers are not directly exposed to the compound, because the chemicals typically are very slowly released, and are enclosed in a dispenser or package. Lastly, because pheromones are not applied directly to crops, they leave no chemical residue on food products such as grains or fruits.

### DISCLOSURE

The present disclosure addresses a need for a safe alternative to conventional methods of behavioral modification of S. incertulas and/or C. suppressalis insects. Embodiments herein comprise pheromone blend compositions that are useful in some embodiments for modifying insect behavior. Specific embodiments include pheromone blend compositions that are surprisingly effective in disrupting mating in S. incertulas and/or C. suppressalis insects, though the compositions comprise pheromones previously thought to be involved in the reproductive isolation of these species through divergent activity in each. In particular examples, the pheromone blend composition is more effective in disrupting mating of an insect species than the naturally occurring pheromone blend composition particular to the insect. In some embodiments, the pheromone blend compositions herein are chemically different than any naturally occurring pheromone composition produced by a female insect of a given target species, and the pheromone blend compositions elicit a different (e.g., synergistically-effective mating disruptive) response from the insect, as compared to a natural pheromone blend.

Some embodiments herein include an insect pheromone blend composition comprising the C. suppressalis pheromone (Z)-13-Octadecenal (Z13-18A1d) and the S. incertulas pheromone (Z)-9-Octadecenal (Z9-18A1d). Naturally occurring C. suppressalis pheromone mixtures do not comprise Z9-18Ald, and naturally-occurring S. incertulas pheromone mixtures do not comprise Z13-18Ald. Some embodiments herein include an insect pheromone blend composition comprising Z13-18Ald, Z9-18Ald, (Z)-9-Hexadecenal (Z9-16A1d), and (Z)-11-Hexadecenal (Z11-16A1d). In other embodiments, an insect pheromone blend composition further comprises at least one additional insect pheromone, which is naturally produced by an insect in some examples and is synthetic in other examples. In particular embodiments, an insect pheromone blend composition further comprises an agriculturally acceptable adjuvant or carrier.

The sex pheromone of the female Chilo suppressalis has been identified as a mixture of Z11-16Ald, Z9-16Ald, 16Ald, and Z13-18Ald (Tatsuki et al. (1983) Appl. Ent. Zool. 18(3):443-6) in a ratio of approximately 1 : 0.3 (Z9-16Ald +16A1d) : 0.09 (Chen et al. (2018) Insects 9:192). In Scirpophaga incertulas, the pheromone is a mixture that contains Z11-16Ald, Z9-16Ald, and Z9-18Ald. Tatsuki et al. (1985) Appl. Ent. Zool. 20(3):357-9. Because C. suppressalis and S. incertulas often occur in the same rice paddy in nature, it has been assumed and expected that the presence of either Z13-18Ald (C. suppressalis) or Z9-18Ald (S. incertulas) in the pheromone prevents cross-attraction between the species so that successful mating can occur. Tatsuki et al. (1985), supra; Chen et al. (2018), supra. Specifically, the understanding in the art is that Z9-18Ald reduces the attractiveness of a pheromone mixture for C. suppressalis. Chen et al. (2018), supra. The presence of Z13-18Ald in a pheromone blend has been shown to not be produce increased mating disruption in S. incertulas. Cork & Souza (1996) Bull. Entomol. Res. 86:515-24.

The present disclosure is based in part on the inventors' unexpected discovery that insect pheromone blend compositions including Z9-18Ald and Z13-18Ald can be used effectively to disrupt mating in SSB and/or YSB insects, contrary to the understanding and expectation in the art. Further, it has been surprisingly discovered that an insect pheromone blend composition including Z9-18Ald and Z13-18Ald in some examples disrupts mating in SSB and/or YSB synergistically, relative to the response of the target insect elicited by its natural pheromone or natural pheromone blend. These surprising properties are attributes of the insect pheromone blend compositions herein, themselves, independently of their manner of use or presentation.

Some embodiments herein provide methods for disrupting mating in either or both of SSB and YSB insects, for example, as part of an insect pest control strategy. The insect pheromone blend composition may be synergistically more effective in disrupting mating than the insect sex pheromone alone. In other embodiments, a method for disrupting mating in an SSB or YSB insect comprises presenting an effective amount of an insect pheromone blend composition described herein to a locus in an environment infested with the insect or at risk of infestation. In particular examples, the locus in such a method may further comprise a mechanism to kill the insect. In some embodiments, a method for disrupting mating in an SSB or YSB insect comprises applying an effective amount of an insect pheromone blend composition described herein to an environment infested with the insect or at risk of infestation

Alternative embodiments herein provide methods for suppressing infestation of either or both of SSB and YSB insects in a given area. In some embodiments, a method for suppressing infestation of either or both of SSB and YSB insects in a given area comprises applying an effective amount of an insect pheromone blend composition described herein within the area (for example, at a locus). In particular examples, applying an effective amount of the insect pheromone blend composition to the area comprises permeating the atmosphere within the area with an effective amount of the insect pheromone blend composition, for example, wherein the composition comprises an agriculturally acceptable adjuvant or carrier. In some examples, applying an effective amount of the insect pheromone blend composition within the area comprises placing within the area a trap or dispenser containing an effective amount of the insect pheromone blend composition.

The foregoing and other features will become more apparent from the following detailed description of several embodiments, which proceeds with reference to the accompanying figures.

### BRIEF DESCRIPTION OF THE DRAWINGS

FIG. 1 includes a stepwise diagram of an experimental design in rice, showing the layout of treatment plots (top row) and control plots (bottom row). The green square is the “main plot,” all of which is planted with rice.

FIG. 2 includes images of a representative pheromone dispenser, showing: (a) the front (left) and back (right), with the silver side facing upwards towards the sun; and (b) a representative pheromone dispenser on a mounting element.

FIG. 3 includes a diagram of treatment plots in the experimental design. Pheromone dispensers are planted over the whole area of the main plot. The blue and yellow square depicts the center 4-hectare data collection area. Blue sub-plots are treated with Endure 120 SC; insecticides are not applied to the yellow sub plot.

FIG. 4 includes the layout showing sub-plot sampling observations made within pheromone plots and control plots. Yellow background represents sub-plot without insecticide; blue background represents sub-plot treated with Endure 120 SC. Purple background represents the buffer between sub plots; distance 25 m from each edge of sub-plot; no sampling. Green spots represent 3 sampling quadrants for each observation taken randomly; 32 hills within 2 m×2 m. Black spots represent harvested sample plot; 5 samples, diagonal point 2.5 m×2.5 m.

FIG. 5 includes a graphical display of data showing high levels of YSB mating disruption in pheromone plots.

FIG. 6 includes a graphical display of data showing improvement of stem borer damage control with higher pheromone blend dispenser densities. Higher pheromone blends improved damage control, with high doses of pheromone blend without insecticide reducing damage to levels obtained with insecticides.

FIG. 7 includes a graphical display of values for the average 7-night trap count for each dose of the non-natural pheromone blend treatment, as a function of the time after installation of the dispenser. Three different locations are graphed separately; Location 1 (A), Location 2 (B), and Location 3 (C). Season-long mating disruption was calculated by summing the average trap counts over the entire sampling period. In FIG. 7, the solid line with circular data points is the control, the hatched line with triangular-shaped data points represents the 4-component blend with 20 dispensers/ha, and the hatched line with the square data points represents the 4-component blend with 30 dispensers/ha.

FIG. 8 includes a graphical display of values for the average 7-night trap count for each dose of a natural 2-component pheromone blend (75% Z11-16Ald, 25% Z9-16A1d) treatment, as a function of the time after installation of the dispenser. Three different locations are graphed separately; Location 1 (A), Location 2 (B), and Location 3 (C). Season-long mating disruption was calculated by summing the average trap counts over the entire sampling period. In FIG. 8, the solid line with circular data points is the control, the hatched line with diamond-shaped data points represents the 2-component blend with 40 dispensers/ha.

FIG. 9 includes a box-whisker plot displaying the distribution of percent mating disruption garnered from a natural 2-component pheromone blend at 40 dispensers/ha, compared to the non-natural 4-component pheromone blend at 20 dispensers/ha and 30 dispensers/ha. Data points represent the percent mating disruption for every sampling date in the 2-component natural and 4-component non-natural pheromone blend treatments. Half of the mating disruptions with the non-natural pheromone blend falls between 84% and 100%, while half of the mating disruption with the natural pheromone blend falls between the lower values of 25% and 87%.

FIG. 10 includes a graphical representation of the number of sampled damaged tillers, summed across all dates for each treatment and location. Percent damage control, compared to control, displayed above each pheromone treatment bar in experiments with the non-natural 4-component pheromone blend (A), and the natural 2-component pheromone blend (B).

### MODE(S) FOR CARRYING OUT THE INVENTION

### I. Overview

Despite reports of pheromone disruption in several insect species, no effective pheromone control strategy for mating disruption in a reproducing population of YSB exists. Embodiments herein utilize the inventors' unexpected discovery that a blend of pheromones from YSB and SSB may disrupt mating in both of these insects, notwithstanding the understanding and expectation in the art that certain compounds in these blends act in nature to allow the insects to distinguish heterologous mating signals, so as to reproductively isolate the species. Specifically, insect pheromone blend compositions including Z9-18Ald and Z13-18Ald may be used effectively to disrupt mating in SSB and/or YSB insects, contrary to the understanding and expectation in the art. Further, it has been surprisingly discovered that an insect pheromone blend composition including Z9-18Ald and Z13-18Ald in some examples disrupts mating in SSB and/or YSB synergistically, relative to the response of the target insect elicited by its natural pheromone or natural pheromone blend. Particular examples herein utilize an insect pheromone blend composition comprising at least the four pheromone compounds Z9-18Ald, Z13-18Ald, Z9-16Ald, and Z11-16Ald, for example, to synergistically disrupt mating of SSB and/or YSB insects in an environment (e.g., an area comprising host plants of the insect).

In some embodiments, the SSB and/or YSB insects targeted by an insect pheromone blend composition of the disclosure infest or cause damage to plants, other organisms, or otherwise causes a nuisance. However, the compositions and methods herein may also be used to target the insects in a non-invasive environment, for example, as part of a procedure to count the number of the insects in an area.

In particular embodiments, an insect pheromone blend composition of the disclosure may disrupt mating in an insect by making it less likely that insects encountering the composition find a successful mate. In other embodiments, an insect may be attracted to an insect pheromone blend composition, for example, by flying toward the pheromone blend composition, or by interacting with an article treated with the pheromone blend composition. Therefore, an insect that is “attracted” to the pheromone blend composition may, or may not, physically contact a locus containing the pheromone blend composition; the pheromone blend composition may in some examples “attract” a given insect within a close proximity to a locus containing the pheromone blend composition without enticing the insect to physically contact the locus. In particular embodiments, an insect pheromone blend composition does “attract” an insect by enticing the insect to physically come into contact with a locus containing the pheromone blend composition.

Insects of the order Lepidoptera produce pheromones that generally consist of unbranched, oxyfunctionalized long-chain olefins containing one to three double bonds. Lepidopteran pheromones are designated by an unbranched aliphatic chain (between 9 and 18 carbons) ending in an alcohol, aldehyde, or acetate functional group, and containing up to 3 double bonds in the aliphatic backbone. For example, the sex pheromones of Helicoverpa zea, Helicoverpa armigera, Plutella xylostella, and Chrysodeixis typically include one or more aliphatic aldehyde compounds having from 10 to 16 carbon atoms (e.g., 7-hexadecenal, 11-hexadecenal, and 13-octadecenal). Other insects, such as Spodoptera frugiperda, recognize pheromones that are aliphatic acetate compounds having from 10 to 16 carbon atoms (e.g., decyl acetate, decenyl acetate, decadienyl acetate, undecyl acetate, undecenyl acetate, dodecyl acetate, dodecenyl acetate, dodecadienyl acetate, tridecyl acetate, tridecenyl acetate, tridecadienyl acetate, tetradecyl acetate, tetradecenyl acetate, and tetradecadienyl acetate). Variation in the location, cis/trans selectivity, level of unsaturation along the chain, and chain length results in a diverse set of pheromones that facilitate species-specific communication. These pheromones are used to attract a mate, sometimes at long distances.

In nature, the olfactory systems of insects are so selective that, for example, male moths discriminate the sex pheromones produced by the conspecific female moths from among similar compounds or mixtures of compounds that have only minimal differences in structure (e.g., chirality). The overall specificity of any sex pheromone is determined by the complete blend of compounds released by conspecific insects, including dominant and minor components. For example, several lepidopteran species utilize a pheromone blend comprising Z11-16:Ald and Z9-16:Ald at different ratios and active doses. The blend consisting of Z11-16:Ald, Z9-16:Ald, and Z13-18:Ald is simplified to be the complete pheromone blend for C. suppressalis. The minor components of pheromone mixtures are generally considered to be very important in modulating their attractiveness in mating behavior.

In C. suppressalis, Z11-16:OH and octadecanal (18:Ald) are minor components in the pheromone gland of female moths (Chen et al. (2018), supra), and these components are generally not included in SSB control mixtures. Mixtures containing Z11-16:Ald, Z9-16:Ald, and Z13-18:Ald were found to frequently trap other insects, such as Scirpophaga incertulas, Mythimna separata, and Helicoverpa armigera in the field. However, pheromone mixtures containing Z11-16:OH failed to attract these other insects, demonstrating that Z11-16:OH renders an otherwise attractive mixture non-attractive for M. separata and H. armigera, maintaining reproductive isolation between these species. The YSB pheromone Z9-18:Ald was believed, prior to the present disclosure, to accomplish the same objective in SSB and YSB, which often occupy the same field environment.

### II. Terms

As used herein, the term “a” as used herein to refer to noun can refer to the singular or the plural version. Thus, a reference to a pheromone can refer to one pheromone or a more than one pheromone.

As used herein, the terms “comprises,” “comprising,” “includes,” “including,” “has,” “having, “contains,” “containing,” or any other variation thereof, are intended to cover a non-exclusive inclusion. A composition, mixture, process, method, article, or apparatus that comprises a list of elements is not necessarily limited to only those elements but may include other elements not expressly listed or inherent to such composition, mixture, process, method, article, or apparatus. Further, unless expressly stated to the contrary, “or” refers to an inclusive “or” and not to an exclusive “or.”

As used herein, the term “about” in reference to a numerical value refers to the range of values somewhat less or greater than the stated value, as understood by one of skill in the art. For example, when understood as such by those in the art, the term “about” may designate a value ranging from plus or minus a percentage (e.g., ±1%, ±2%, ±5%, or ±10%) of the stated value. The term “about” may also designate a set of numerical values that all approximate, or round to, the same number. Furthermore, since all numbers, values, and expressions referring to quantities used herein are subject to the various uncertainties of measurement encountered in the art, then unless otherwise indicated, all presented values may be understood as modified by the term “about.”

An “effective amount” means that amount of the disclosed pheromone composition that is sufficient to affect desired results. An effective amount can be administered in one or more administrations. For example, an effective amount of the composition may refer to an amount of the pheromone composition that is sufficient to disrupt mating of a particular insect population of interest in a given locality.

As used herein, the term “synergy” or “synergistic” refers to an insect pheromone blend composition that exhibits a synergistic mating disruptive effect on YSB or SSB insects. The synergistic attractive effect obtained can be quantified according to Colby's formula:

$$( E ) = X + Y - ( X * Y / 100 )$$

Colby (1967) Weeds 15(1):20-22, incorporated herein by this reference in its entirety. Thus, by “synergistic” is intended a component which, by virtue of its presence, increases the desired effect by more than an additive amount. The pheromone compositions herein can act synergistically to increase a mating disruptive property of the composition beyond the additive effects of the individual pheromone components.

### III. YSB and SSB Insect Pheromone Blend Compositions

Embodiments herein include an insect pheromone blend composition comprising Z13-18Ald and Z9-18Ald, which compounds are not found together in naturally occurring YSB or SSB pheromone mixtures. In particular embodiments, the insect pheromone blend composition may comprise Z9-18Ald and Z13-18Ald in a ratio of between about 0.4:1 and about 1.4:1 by weight. For example, specific insect pheromone blend compositions herein comprise Z9-18A1d and Z13-18Ald in a ratio selected from the group consisting of 0.4:1, 0.5:1, 0.6:1, 0.7:1, 0.8:1, 0.9:1, 1:1, 1.1:1, 1.2:1, 1.3:1, and 1.4:1.

Some embodiments herein include an insect pheromone blend composition comprising Z11-16Ald, Z9-16Ald, Z13-18Ald, and Z9-18Ald. In particular embodiments, the insect pheromone blend composition may comprise Z11-16Ald in an amount between about 50% and about 86% a.i. (e.g., 50%-84%, 50%-70%, 50%-73.7%, 50%-75%, 50%-81%, 50%-84%, 50%-86%, 58%-70%, 58%-73.7%, 58%-75%, 58%-81%, 58%-84%, 58%-86%, 70%-73.7%, 70%-75%, 70%-81%, 70%-84%, 70%-86%, 73.7%-75%, 73.7%-81%, 73.7%-84%, 73.7%-86%, 75%-81%, 75%-84%, 75%-86%, 81%-84%, 81%-86%, 84%-86%, about 58%, about 70%, about 73.7%, about 75%, about 81%, and about 84%). In certain examples, the insect pheromone blend composition may comprise Z11-16Ald in an amount between 58%-84%. In particular embodiments, the insect pheromone blend composition may comprise Z9-16Ald in an amount between about 4% and about 20% a.i. (e.g., 5%-14%, 4%-7%, 4%-8%, 4%-9%, 4%-10%, 4%-14%, 4-15%, 4%-20%, 5%-7%, 5%-8%, 5%-9%, 5%-10%, 5%-14%, 5%-15%, 5%-20%, 7%-8%, 7%-9%, 7%-10%, 7%-14%, 7%-15%, 7%-20%, 8%-9%, 8%-10%, 8%-14%, 8%-15%, 8%-20%, 9%-10%, 9%-14%, 9%-15%, 9%-20%, about 4%, about 4.5%, about 5%, about 6%, about 7%, about 8%, about 9%, about 10%, about 14%, and about 15%). In certain examples, the insect pheromone blend composition may comprise Z9-16Ald in an amount between 5%-14%. In particular embodiments, the insect pheromone blend composition may comprise Z13-18Ald in an amount between about 4% and about 20% a.i. (e.g., 5%-14%, 4%-7%, 4%-10%, 4%-13%, 4%-14%, 4-15%, 4%-20%, 5%-7%, 5%-10%, 5%-13%, 5%-14%, 5%-15%, 5%-20%, 7%-10%, 7%-13%, 7%-14%, 7%-15%, 7%-20%, about 4%, about 4.5%, about 5%, about 6%, about 7%, about 10%, about 13%, about 14%, and about 15%). In certain examples, the insect pheromone blend composition may comprise Z13-18Ald in an amount between 5%-14%. In particular embodiments, the insect pheromone blend composition may comprise Z9-18Ald in an amount between about 4% and about 20% a.i. (e.g., 5%-14%, 4%-7%, 4%-10%, 4%-14%, 4-15%, 4%-20%, 5%-7%, 5%-10%, 5%-14%, 5%-15%, 5%-20%, 7%-10%, 7%-14%, 7%-15%, 7%-20%, about 4%, about 4.5%, about 5%, about 6%, about 7%, about 10%, about 14%, and about 15%). In certain examples, the insect pheromone blend composition may comprise Z9-18Ald in an amount between 5%-14%. In some embodiments, the pheromone blend is described as comprising Z11-16Ald, Z9-16Ald, Z13-18Ald, and Z9-18Ald, wherein it does not comprise Z11-16Ald in an amount of about 75%, or does not comprise Z9-16Ald in an amount of about 25%.

An insect pheromone blend composition according to any of the foregoing embodiments may also further comprise an additional component, for example, adjuvants, baits, feeding stimulants (e.g., for example and without limitation, crude cottonseed oil, fatty acid esters of phytol, fatty acid esters of geranyl geraniol, fatty acid esters of other plant alcohols, and plant extracts), and other compounds that do not substantially interfere with the mating disruptive activity of the composition.

The insect pheromone blend compositions herein may be used in a variety of insect control strategies, including mating disruption, attract-and-kill, and mass trapping. These strategies have proven to be effective. Furthermore, the compositions are generally biodegradable and do not accumulate in the food chain. The high selectivity of pheromones allows farmers to control the population of the target pest while causing minimal disruption to the ecology in the field; for example, the compositions do not harm beneficial insects, such as bees and lady bugs. Because the insect pheromone blend compositions may be used to act via non-toxic mating disruption, they may be effectively deployed to manage insects that have evolved resistance to chemical or transgenic insecticides.

In some embodiments, insect pheromone blend compositions herein may be used to modify the behavior of insects in an agricultural setting, e.g., by applying the pheromone blend compositions to a locus thereby disrupting mating in a target insect. Therefore, the pheromone blend compositions herein include in some examples “agricultural compositions,” which may further comprise agriculturally-acceptable additives including, for example and without limitation, wetting agents, compatibility agents, antifoam agents, cleaning agents, sequestering agents, drift reduction agents, neutralizing agents, buffers, corrosion inhibitors, dyes, odorants, spreading agents (also referred to as “spreaders”), penetration aids (also referred to as “penetrants”), sticking agents (also referred to as “stickers” or “binders”), dispersing agents, thickening agents (also referred to as “thickeners”), stabilizers, surface-active agents, emulsifiers, freezing point depressants, preservatives, and antimicrobial agents.

Insect pheromone blend compositions herein may therefore specifically comprise a stabilizer, including, for example and without limitation, fatty acids and vegetable oils (e.g., olive oil, soybean oil, corn oil, safflower oil, and canola oil); a filler, including, for example and without limitation, mineral clays (e.g., attapulgite), a thickener, including, for example and without limitation, organic thickeners, methyl cellulose, and ethyl cellulose.

In some examples, an insect pheromone blend composition may include a carrier, such as, for example, an inert liquid or solid. Representative, non-limiting examples of solid carriers that may be comprised within an insect pheromone blend composition herein include fillers such as kaolin, bentonite, dolomite, calcium carbonate, talc, powdered magnesia, Fuller's earth, wax, gypsum, diatomaceous earth, rubber, plastic, China clay, mineral earths such as silicas, silica gels, silicates, attaclay, limestone, chalk, loess, clay, dolomite, calcium sulfate, magnesium sulfate, magnesium oxide, ground synthetic materials, fertilizers (e.g., ammonium sulfate, ammonium phosphate, ammonium nitrate, thiourea, and urea), vegetable products (e.g., cereal meals, tree bark meal, wood meal, and nutshell meal), cellulose powders, attapulgites, montmorillonites, mica, vermiculites, synthetic silicas, and synthetic calcium silicates.

Representative, non-limiting examples of liquid carriers that may be comprised within an insect pheromone blend composition herein include water, alcohols (e.g., ethanol, methanol, butanol, glycol), aqueous solvent (e.g., mixtures of water and alcohols), ethers and esters (e.g., methylglycol acetate), ketones (e.g., acetone, cyclohexanone, methylethyl ketone, methylisobutylketone, and isophorone), alkanes (e.g., hexane, pentane, and heptanes), aromatic hydrocarbons (e.g., xylenes and alkyl naphthalenes), petroleum solvents, turpentine, mineral oils, vegetable oils, aliphatic chlorinated hydrocarbons (e.g., trichloroethane and methylene chloride), aromatic chlorinated hydrocarbons (e.g., chlorobenzenes), water-soluble or strongly polar solvents (e.g., dimethylformamide, dimethyl sulfoxide, and N-methylpyrrolidone), liquefied gases, waxes (e.g., beeswax, lanolin, shellac wax, carnauba wax, fruit wax, candelilla wax, microcrystalline wax, ozocerite, ceresin, and montan), salts (e.g., monoethanolamine salt, sodium sulfate, potassium sulfate, sodium chloride, potassium chloride, sodium acetate, ammonium hydrogen sulfate, ammonium chloride, ammonium acetate, ammonium formate, ammonium oxalate, ammonium carbonate, ammonium hydrogen carbonate, ammonium thiosulfate, ammonium hydrogen diphosphate, ammonium dihydrogen monophosphate, ammonium sodium hydrogen phosphate, ammonium thiocyanate, ammonium sulfamate, and ammonium carbamate). Insect pheromone blend composition containing liquid carriers are particularly desirable when the composition is desired to be a liquid composition for application by brushing, dipping, rolling, spraying, or otherwise applying the liquid compositions to substrates on which a pheromone coating is to be provided (e.g., a lure). Accordingly, a liquid carrier may be selected to solubilize, or substantially solubilize, the one or more ingredients of the pheromone composition.

Insect pheromone blend compositions herein may specifically comprise a binder. Binders can be used to promote association of the pheromone composition with the surface of a material coated with the composition. In some embodiments, the binder can be used to promote association of another additive (e.g., insecticides and insect growth regulators) to the pheromone composition and/or the surface of a material. For example, a binder may include a synthetic or natural resin; these may be modified to cause the coated surface to be friable enough to allow insects to bite off and ingest the components of the composition, while still maintaining the structural integrity of the coating.

Representative, non-limiting examples of binders include polyvinylpyrrolidone, polyvinyl alcohol, partially hydrolyzed polyvinyl acetate, carboxymethylcellulose, starch, vinylpyrrolidone/vinyl acetate copolymers and polyvinyl acetate, lubricants, magnesium stearate, sodium stearate, talc, and polyethylene glycol, antifoams, silicone emulsions, long-chain alcohols, phosphoric esters, acetylene diols, fatty acids, organofluorine compounds, and complexing agents (e.g., salts of ethylenediaminetetraacetic acid (EDTA), salts of trinitrilotriacetic acid, and salts of polyphosphoric acids). Non-limiting examples of binders include, shellac, acrylics, epoxies, alkyds, polyurethanes, linseed oil, and tung oil. In some embodiments, the pheromone compositions of the present disclosure comprise emulsifying agents. An emulsifying agent is a substance, which stabilizes a suspension of droplets of one liquid phase in another liquid phase. Without the emulsifying agent the two liquids would separate into two immiscible liquid phases. In some embodiments, the most commonly used emulsifier blends include alkylphenol or aliphatic alcohol with 12 or more ethylene oxide units and the oil-soluble calcium salt of dodecylbenzene sulphonic acid. A range of hydrophile-lipophile balance (“HLB”) values from 8 to 18 will normally provide good stable emulsions. In some embodiments, emulsion stability can sometimes be improved by the addition of a small amount of an EO-PO block copolymer surfactant.

Insect pheromone blend compositions herein may specifically comprise a solubilizing agent, including, for example and without limitation, a surface-active agent, such as a surfactant that form micelles in water at concentrations above the critical micelle concentration. The micelles are then able to dissolve or solubilize water-insoluble materials inside the hydrophobic part of the micelle. In some embodiments, the surface-active agents are added to liquid agricultural compositions. In other embodiments, the surface-active agents are added to solid formulations, for example, those designed to be diluted with a carrier before application. Surfactants are sometimes used, either alone or with other additives (such as mineral or vegetable oils) as adjuvants to spray-tank mixes to improve the biological performance of the pheromone on the target. A surface-active agent may be anionic, cationic, or nonionic in character, and one or more can be employed as an emulsifying agent, wetting agent, suspending agent, or for another purpose.

Representative surfactants usable for solubilization include nonionics (e.g., alky ethoxylates, linear aliphatic alcohol ethoxylates, and aliphatic amine ethoxylates), sorbitol esters (e.g., sorbitol oleate), sorbitan monooleates, sorbitan monooleate ethoxylates, methyl oleate esters, alkali metal, alkaline earth metal or ammonium salts of aromatic sulfonic acids, for example, ligno-, phenol-, naphthalene- and dibutylnaphthalenesulfonic acid, and of fatty acids of arylsulfonates, of alkyl ethers, of lauryl ethers, of fatty alcohol sulfates and of fatty alcohol glycol ether sulfates, condensates of sulfonated naphthalene and its derivatives with formaldehyde, condensates of naphthalene or of the naphthalenesulfonic acids with phenol and formaldehyde, condensates of phenol or phenolsulfonic acid with formaldehyde, condensates of phenol with formaldehyde and sodium sulfite, polyoxyethylene octylphenyl ether, ethoxylated isooctyl-, octyl- or nonylphenol, tributylphenyl polyglycol ether, alkylaryl polyether alcohols, isotridecyl alcohol, ethoxylated castor oil, ethoxylated triarylphenols, salts of phosphated triarylphenolethoxylates, lauryl alcohol polyglycol ether acetate, lignin-sulfite waste liquors, and methylcellulose.

Surfactants conventionally used in the art of formulation that may also be used in and with the present compositions are described, for example, in McCutcheon's Detergents and Emulsifiers Annual, MC Publishing Corp., Ridgewood, N.J., 1998, and in Encyclopedia of Surfactants, Vols. I-III, Chemical Publishing Co., New York, 1980-81. In some embodiments, the present disclosure teaches the use of surfactants including, or compositions of these.

Other representative, non-limiting examples of surface-active agents include salts of alkyl sulfates (e.g., diethanolammonium lauryl sulfate), alkylarylsulfonate salts (e.g., calcium dodecylbenzenesulfonate), alkylphenol-alkylene oxide addition products (e.g., nonylphenol-C18 ethoxylate), alcohol-alkylene oxide addition products (e.g., tridecyl alcohol-C16 ethoxylate), soaps (e.g., sodium stearate), alkylnaphthalene-sulfonate salts (e.g., sodium dibutyl-naphthalenesulfonate), dialkyl esters of sulfosuccinate salts (e.g., sodium di(2-ethylhexyl)sulfosuccinate), quaternary amines (e.g., lauryl trimethylammonium chloride), polyethylene glycol esters of fatty acids (e.g., polyethylene glycol stearate), block copolymers of ethylene oxide and propylene oxide, salts of mono and dialkyl phosphate esters, vegetable oils (e.g., soybean oil, rapeseed/canola oil, olive oil, castor oil, sunflower seed oil, coconut oil, corn oil, cottonseed oil, linseed oil, palm oil, peanut oil, safflower oil, sesame oil, and tung oil), and esters of the above vegetable oils, particularly methyl esters.

Insect pheromone blend compositions herein may specifically comprise a wetting agent. A wetting agent is a substance that increases the spreading or penetration power of the liquid when added to the liquid by reducing the interfacial tension between the liquid and the surface on which it is spreading. In agrochemical formulations wetting agents are typically used during processing and manufacture to increase the rate of wetting of powders in water to make concentrates for soluble liquids or suspension concentrates. Wetting agents are also useful in agriculture during mixing of a product with water in a spray tank or other vessel to reduce the wetting time of wettable powders, and to improve the penetration of water into water-dispersible granules. Insect pheromone blend compositions herein may specifically comprise a wetting agent, including, for example and without limitation, wettable powders, suspension concentrates, and water-dispersible granule formulations (e.g., sodium lauryl sulphate, sodium dioctyl sulphosuccinate, alkyl phenol ethoxylates, and aliphatic alcohol ethoxylates).

Insect pheromone blend compositions herein may specifically comprise a thickener or “gelling agent.” Thickeners or gelling agents are used mainly in the formulation of suspension concentrates, emulsions, and suspoemulsions to modify the rheology or flow properties of the liquid, and to prevent separation and settling of dispersed particles or droplets. Thickening, gelling, and anti-settling agents generally fall into two categories, namely water-insoluble particulates and water-soluble polymers. It is possible to produce suspension concentrate formulations using clays and silicas. In some embodiments, the pheromone compositions comprise one or more thickeners including, but not limited to: montmorillonite, e.g. bentonite; magnesium aluminum silicate; and attapulgite. In some embodiments, the present disclosure teaches the use of polysaccharides as thickening agents. The types of polysaccharides most commonly used are natural extracts of seeds and seaweeds, or synthetic derivatives of cellulose. Some embodiments utilize xanthan, and some embodiments utilize cellulose. In some embodiments, the present disclosure teaches the use of thickening agents including, for example and without limitation, guar gum, locust bean gum, carrageenan, alginates, methyl cellulose, sodium carboxymethyl cellulose (SCMC), and hydroxyethyl cellulose (HEC). In some embodiments, an insect pheromone blend composition herein comprises other types of anti-settling agents, such as modified starches, polyacrylates, polyvinyl alcohol, and polyethylene oxide. Another good anti-settling agent is xanthan gum.

Insect pheromone blend compositions herein may specifically comprise as anti-foam agent. In some embodiments, the presence of surfactants, which lower interfacial tension, can cause water-based formulations to foam during mixing operations in production and in application through a spray tank. Thus, in some embodiments, in order to reduce the tendency to foam, anti-foam agents are often added either during the production stage, or before filling into bottles/spray tanks. Generally, there are two types of anti-foam agents, namely silicones and nonsilicones. Silicones are usually aqueous emulsions of dimethyl polysiloxane, while the nonsilicone anti-foam agents are water-insoluble oils, such as octanol and nonanol, or silica. In both cases, the function of the anti-foam agent is to displace the surfactant from the air-water interface.

In some embodiments, insect pheromone blend compositions herein may be used to disrupt insect mating as part of an insect control strategy, e.g., by applying the pheromone blend compositions to a locus containing an effective amount of an insecticide that kills the insect, an insect growth regulator (“IGR”), and/or an insect sterilant.

Therefore, the insect pheromone blend compositions herein may include one or more insecticides. Non-limiting examples of chemical insecticides that may be included in an insect pheromone blend composition include pyrethoroid or organophosphorus insecticides; for example, cyfluthrin, permethrin, cypermethrin, bifinthrin, fenvalerate, flucythrinate, azinphosmethyl, methyl parathion, buprofezin, pyriproxyfen, flonicamid, acetamiprid, dinotefuran, clothianidin, acephate, malathion, quinolphos, chloropyriphos, profenophos, bendiocarb, bifenthrin, chlorpyrifos, cyfluthrin, diazinon, pyrethrum, fenpropathrin, kinoprene, insecticidal soap or oil, neonicotinoids, diamides, avermectin and derivatives, spinosad and derivatives, azadirachtin, and pyridalyl.

Non-limiting examples of biological insecticides that may be included in an insect pheromone blend composition include azadirachtin (neem oil), toxins from natural pyrethrins, Bacillus thuringiencis, Bacillus sphaericus, and Beauveria bassiana, viruses (e.g., CYD-X™, CYD-X HP™, Germstar™ Madex H P™ and Spod-X™), and insecticidal peptides (e.g., Spear-T™, Spear-P™, and Spear-C™)

Non-limiting examples of insecticides that may be included in an insect pheromone blend composition include insecticides that target insect nerve, muscle, respiration, or growth and development; for example, acetylcholinesterase (AChE) inhibitors (e.g., carbamates and organophosphates), GABA-gated chloride channel antagonists (e.g., cyclodiene organochlorines and phenylpyrazoles), sodium channel modulators (e.g., pyrethrins and pyrethroids), nicotinic acetylcholine receptor (nAChR) agonists (e.g., neonicotinoids), nicotinic acetylcholine receptor (nAChR) allosteric modulators (e.g., spinosyns), chloride channel activators (e.g., avermectins and milbemycins), nAChR) blockers (e.g., bensultap and cartap), voltage dependent sodium channel blockers (e.g., indoxacarb and metaflumizone), ryanodine receptor modulators (e.g., diamides), chemicals that uncouple oxidative phosphorylation via disruption of the proton gradient (e.g., chlorfenapyr and mitochondrial complex I electron transport inhibitors), insect juvenile hormone mimics (e.g., fenoxycarb), inhibitors of chitin biosynthesis, Type 0 (e.g., benzoylureas, flufenoxuron, lufenuron, and novaluron), and ecdysone receptor agonists (e.g., diacylhydrazines, methoxyfenozide, and tebufenozide).

The insect pheromone blend compositions herein may include one or more insecticides one or more IGRs, which may be used to alter the growth of the insect and produce deformed insects. Non-limiting examples of insect growth regulators include dimilin. Also, insect pheromone blend compositions may include one or more insect sterilants that sterilize the trapped insects or otherwise block their reproductive capacity, thereby reducing the population in the following generation. In some situations, allowing sterilized insects to survive and compete with non-trapped insects for mates is more effective than killing them outright.

In some embodiments, an insect pheromone blend composition may comprise a preservative. In some examples, an insect pheromone blend composition may comprise mixtures of any of the foregoing.

In other embodiments, the insect pheromone blend compositions herein are formulated as a sprayable composition. An aqueous solvent can be used in the sprayable composition; e.g., water, or a mixture of water and an alcohol, glycol, ketone, or other water-miscible solvent. In particular embodiments, the water content of an insect pheromone blend composition sprayable formulation may be any of at least about 10%, at least about 20%, at least about 30%, at least about 40%, at least about 50%, at least about 60%, at least about 70%, at least about 80%, or at least about 90% of the formulation, and any specific water content within the foregoing ranges. In some embodiments, the sprayable composition is a concentrate; i.e., a concentrated suspension of the pheromone and other additives in the aqueous solvent, and it can be diluted to the final use concentration by addition of solvent (e.g., water).

In alternative embodiments, the insect pheromone blend compositions herein may be formulated so as to provide slow release into the atmosphere, and/or so as to be protected from degradation following release. For example, the pheromone compositions can be included in carriers such as microcapsules, biodegradable flakes, and paraffin wax-based matrices. Alternatively, the pheromone composition can be formulated as a slow release sprayable. In particular examples, the insect pheromone blend compositions herein can be formulated as a microencapsulated pheromone. Microencapsulated pheromones (MECs) are small droplets of pheromone enclosed within polymer capsules. The capsules control the release rate of the pheromone into the surrounding environment, and they are small enough to be applied in the same method as used to spray insecticides. The effective field longevity of the microencapsulated pheromone formulations can range from a few days to slightly more than a week.

In certain embodiments, the insect pheromone blend compositions herein may include one or more polymeric agents known to one skilled in the art that control the rate of release of the composition to the environment. In some examples, an insect pheromone blend composition comprising such a polymeric agent is impervious to environmental conditions. The polymeric agent may also be a sustained-release agent that enables the composition to be released to the environment in a sustained manner. Non-limiting examples of polymeric agents include celluloses (e.g., methylcellulose, ethyl cellulose, cellulose acetate, cellulose acetate-butyrate, cellulose acetate-propionate, and cellulose propionate), proteins (e.g., casein), fluorocarbon-based polymers, hydrogenated rosins, lignins, melamine, polyurethanes, vinyl polymers (e.g., polyvinyl acetate (PVAC)), polycarbonates, polyvinylidene dinitrile, polyamides, polyvinyl alcohol (PVA), polyamide-aldehyde, polyvinyl aldehyde, polyesters, polyvinyl chloride (PVC), polyethylenes, polystyrenes, polyvinylidene, and silicones. Other agents which can be used in slow-release or sustained-release formulations include fatty acid esters (e.g., a sebacate, laurate, palmitate, stearate, or arachidate ester), and fatty alcohols (e.g., undecanol, dodecanol, tridecanol, tridecenol, tetradecanol, tetradecenol, tetradecadienol, pentadecanol, pentadecenol, hexadecanol, hexadecenol, hexadecadienol, octadecenol and octadecadienol).

### IV. Administration of Insect Pheromone Blend Composition

According to certain embodiments, the insect pheromone blend compositions herein may be used in conjunction with any type of appropriate trap or chemical disseminator known in the art. The composition may be applied or disseminated using any of a variety of conventional techniques, such as in an exposed solution, impregnated wicking material or other substrate, or incorporated in a dispenser. Further, the insect pheromone blend compositions may be combined in a single dispenser provided within a single trap, or provided separately in a plurality of dispensers, all within a single trap. The compound or compositions of the invention may be applied to a trap undiluted or formulated in an inert carrier. Volatilization may be controlled or retarded by inclusion of an extender, such as mineral oil. Controlled release over an extended period of time may also be achieved by placement of the compound or compositions of the invention within vials, within a permeable septum or cap, by encapsulation using conventional techniques, or absorption into a porous substrate.

In some embodiments, the pheromone blend compositions herein are used in conjunction with a dispenser for release of the composition in a particular environment. Any suitable dispenser known in the art can be used. Examples of such dispensers include, for example and without limitation, aerosol emitters, hand-applied dispensers, bubble caps comprising a reservoir with a permeable barrier through which pheromones are slowly released, pads, beads, tubes, rods, spirals or balls composed of rubber, plastic, leather, cotton, cotton wool, wood, wood products that are impregnated with the pheromone composition, polyvinyl chloride laminates, pellets, granules, ropes or spirals from which the pheromone composition evaporates, and rubber septa. One of skill in the art will be able to select suitable carriers and/or dispensers for the desired mode of application, storage, transport, and/or handling conditions.

In another embodiment, a device may be used that contaminates the male insects with a powder containing the pheromone blend composition itself. The contaminated males then fly off and provide a source of mating disruption by permeating the atmosphere with the pheromone substance, or by attracting other males to the contaminated males, rather than to real females.

In some embodiments, the pheromone blend compositions herein are used to disrupt mating. Mating disruption is a pest management technique designed to control insect pests by introducing artificial stimuli (e.g., an effective pheromone composition as disclosed herein) that confuses the insects and disrupts mating localization and/or courtship, thereby preventing mating and blocking the reproductive cycle.

In many insect species of interest to agriculture, such as YSB and SSB, females emit an airborne trail of a specific chemical blend constituting that species' sex pheromone. This aerial trail is referred to as a pheromone plume. Males of that species use the information contained in the pheromone plume to locate the emitting female (known as a “calling” female). Mating disruption exploits the male insects' natural response to follow the plume by introducing a pheromone into the insects' habitat that mimics the sex pheromone produced by the female insect. The general effect of mating disruption is to confuse the male insects by masking the natural pheromone plumes, causing the males to follow “false pheromone trails” at the expense of finding mates, and affecting the males' ability to respond to “calling” females. Consequently, the male population experiences a reduced probability of successfully locating and mating with females, which leads to the eventual cessation of breeding and collapse of the insect infestation. As described above, it has been surprisingly discovered that insect pheromone blend compositions containing Z9-18Ald, which is not produced by SSB, effectively disrupts mating in SSB.

Particular strategies of mating disruption include confusion, trail-masking, and false-trail following. Constant exposure of insects to a high concentration of a pheromone can prevent male insects from responding to normal levels of the pheromone released by female insects. Trail-masking uses a pheromone to destroy the trail of pheromones released by females. False-trail following is carried out by laying numerous spots of a pheromone in high concentration to present the male with many false trails to follow. When released in sufficiently high quantities, the male insects are unable to find the natural source of the sex pheromones (the female insects), so that mating cannot occur.

In some embodiments, a wick or trap may be adapted to emit a pheromone blend composition herein for a period at least equivalent to the breeding season(s) of YSB and/or SSB, thus causing mating disruption. If the insect has an extended breeding season, or repeated breeding season, the present disclosure provides a wick or trap capable of emitting the pheromone blend composition for a period of time (e.g., about two weeks, between about 1 and 4 weeks, and up to 6 weeks), which may be rotated or replaced by subsequent similar traps. A plurality of traps containing the pheromone blend composition may be placed in a locus; e.g., adjacent to a crop field. The locations of the traps, and the height of the traps from ground, may be selected in accordance with methods known to one skilled in the art.

Alternatively, the insect pheromone blend compositions of the present disclosure may be dispensed from formulations such as microcapsules or twist-ties, such as are commonly used for disruption of the mating of insect pests. The pheromone blend compositions may alternatively be coated on or sprayed on a lure, or the lure may be otherwise impregnated with a pheromone composition.

In particular embodiments, the insect pheromone blend compositions may be used in traps, such as those commonly used to attract any insect species; e.g., insects of the order Lepidoptera. Such traps are commonly used in many states and countries in insect eradication programs. In one embodiment, the trap includes one or more septa, containers, or storage receptacles for holding the pheromone blend composition. Thus, in some embodiments, the present disclosure provides a trap loaded with at least one pheromone composition. Thus, the pheromone compositions of the present disclosure can be used in traps for example to attract insects as part of a strategy for insect monitoring, mass trapping, mating disruption, or lure/attract and kill, for example, by incorporating a toxic substance into the trap to kill insects caught. Traps may be placed within an environment to overwhelm the pheromones emitted by the females, so that the males simply cannot locate the females. In this respect, a trap need be nothing more than a simple apparatus, for example, a protected wickable to dispense pheromone.

Mass trapping involves placing a high density of traps in a crop to be protected so that a high proportion of the insects are removed before the crop is damaged. Lure/attract-and-kill techniques are similar. except that once the insect is attracted to a lure, it is subjected to a killing agent. Where the killing agent is an insecticide, a dispenser can also contain a bait or feeding stimulant that will entice the insects to ingest an effective amount of an insecticide. The insecticide may be an insecticide known to one skilled in the art. The insecticide may be mixed with the attractant-composition or may be separately present in a trap. Mixtures may perform the dual function of attracting and killing the insect.

Such traps may take any suitable form, and killing traps need not necessarily incorporate toxic substances, the insects being optionally killed by other means, such as drowning or electrocution. Alternatively, the traps can contaminate the insect with a fungus or virus that kills the insect later. Even where the insects are not killed, the trap can serve to remove the male insects from the locale of the female insects, to prevent breeding.

It will be appreciated by a person skilled in the art that a variety of different traps are possible. Suitable examples of such traps include water traps, sticky traps, and one-way traps. Sticky traps come in many varieties. One example of a sticky trap is of cardboard construction, triangular or wedge-shaped in cross-section, where the interior surfaces are coated with a non-drying sticky substance. The insects contact the sticky surface and are caught. Water traps include pans of water and detergent that are used to trap insects. The detergent destroys the surface tension of the water, causing insects that are attracted to the pan, to drown in the water. One-way traps allow an insect to enter the trap but prevent it from exiting. The traps of the disclosure may be colored brightly in some examples, to provide additional attraction for the insects.

In some embodiments, pheromone traps containing the pheromone blend composition may be combined with other kinds of trapping mechanisms. For example, in addition to the pheromone blend composition, the trap may include one or more florescent lights, one or more sticky substrates, and/or one or more colored surfaces for attracting moths. In other embodiments, the pheromone trap containing the composition may not have other kinds of trapping mechanisms. The trap may be set at any time of the year in a field. Those of skill in the art determine an appropriate amount of the pheromone blend composition to use in a particular trap, and an appropriate density of traps/acre of crop field to be protected, according to the particular application and within their discretion. The trap can be positioned in an area infested (or potentially infested) with insects. Generally, the trap is placed on or close to a tree or plant. The aroma of the pheromone may attract the insects to the trap. The insects can then be caught, immobilized and/or killed within the trap, for example, by a killing agent present in the trap.

The traps or dispensers of the present disclosure may be provided in made-up form, where the pheromone blend composition of the disclosure has already been applied. In such an instance, the composition may be exposed, or may be sealed in conventional manner, such as is standard with other aromatic dispensers, the seal only being removed once the trap is in place. Alternatively, the traps may be sold separately, and the pheromone blend composition of the disclosure provided in dispensable format, so that an amount may be applied to the trap once the trap is in place. Thus, the present disclosure may provide the compound in a sachet or other dispenser.

The following EXAMPLES are provided to illustrate certain particular features and/or embodiments. The EXAMPLES should not be construed to limit the disclosure to the particular features or embodiments exemplified.

### EXAMPLES

### Example 1: Synergistic Control of Scirpophaga incertulas with 4 Pheromone Blend

### Materials and Methods

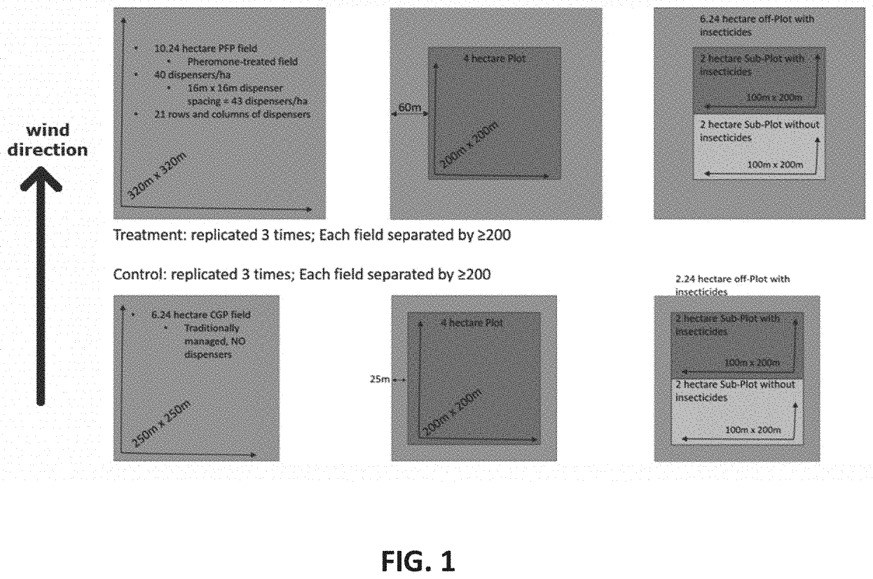

Insect control experiments are carried out using a split plot design with three replications. Two “main plots” are treated in 3 replicates with either a sachet dispenser of mating disruption pheromone, or a non-pheromone control. Each of 2 “sub plot” within the main plots treated with YSB insecticide (Endure 12 SC) and without YSB insecticide where the data is collected. FIG. 1.

The selected experimental land consists of irrigated, conventionally cultivated rice fields, in plots of 10.24 Ha, equivalent to 320 m×320 m pheromone test plat, and 4 Ha, equivalent to 200 m×200 m control plot (without pheromone blend). The distance between each main plot of pheromone test is ≥400 m (500 m away from light traps), and the distance between the pheromone test plot and the control plot is about ≥225 m. The sub-plot is located within a main plot (center 4 Ha divided into 2; 2 Ha halves is equivalent to 100 m×200 m). Two treatments are conducted within the sub-plots: (1) cultivation with commonly used application of YSB insecticide, and (2) cultivation in sub-plots without YSB insecticide. FIG. 1.

All plots contain Ciherang rice variety, and receive the same agronomic practices; fertilizer, plant spacing, herbicide, etc. In YSB insecticide plots, YSB insecticide (Endure 120 SC (a.i. Spinetoram) is applied at a typical effective frequency (375 mL/ ha, spray volume of 300 L/ ha, concentration 1.25 mL/ L). When the YSB moth is caught in a light trap, control is carried out 4 days after the moth is caught, both in the vegetative and generative stage of plants.

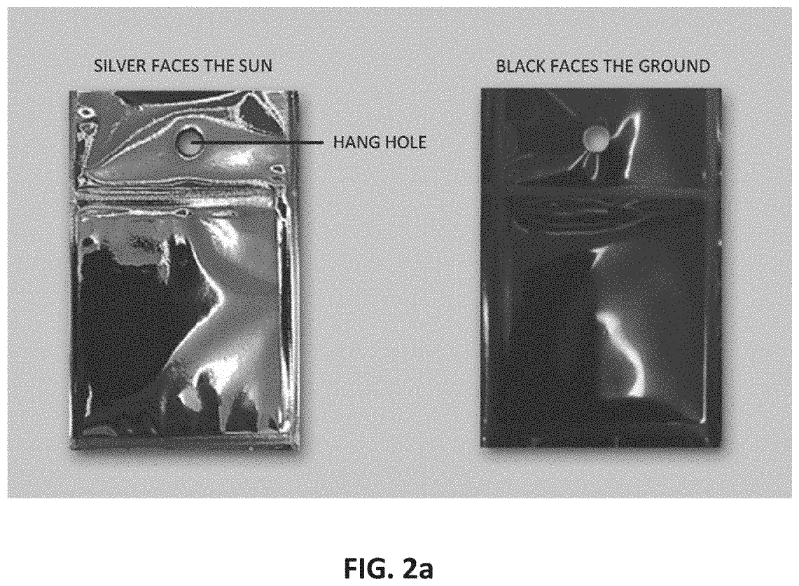

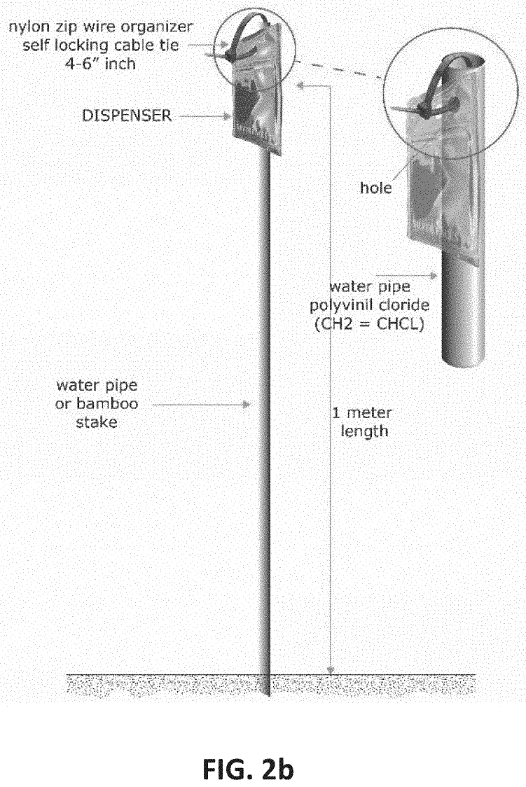

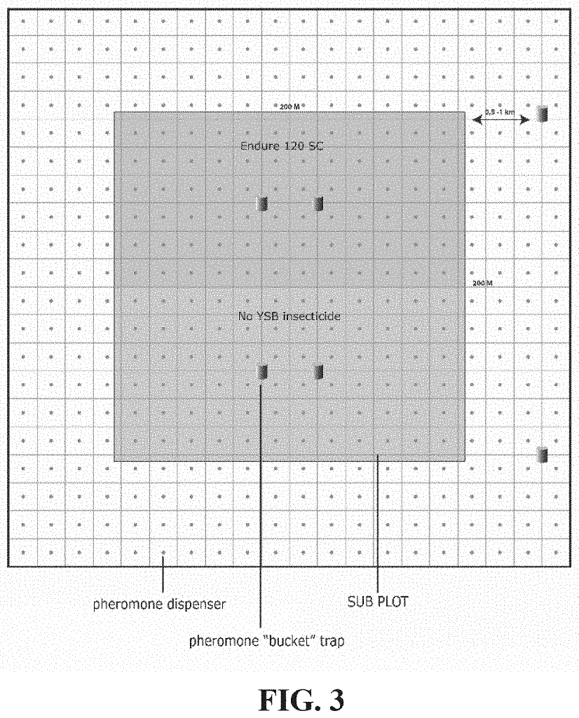

Pheromones are applied by installing dispensers across the entire 10.24-ha main plot, in a 16 m×16 m grid. FIG. 3. Dispensers are mounted on wooden or bamboo stakes at the final level of the crop canopy (˜1 meter above ground) (FIG. 2b), and touching only the un-sealed installation tab, and with the silver colored side facing upwards towards the sun (FIG. 2a).

Dispensers are installed within a row of rice plants at the time of transplanting and kept in the field until harvest. FIG. 3. In control plots, no pheromone is applied over the entire sub-plot. In sub-plots, the entire main plot (of both pheromone and control plots) is treated with YSB insecticides, except for one, 2-hectare rectangle sub-plot as a no-YSB chemical control. FIG. 3.

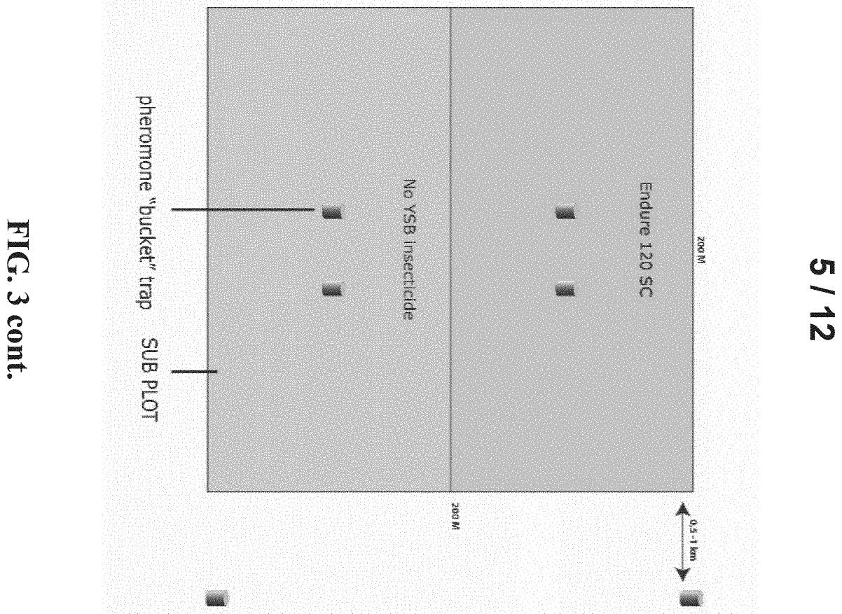

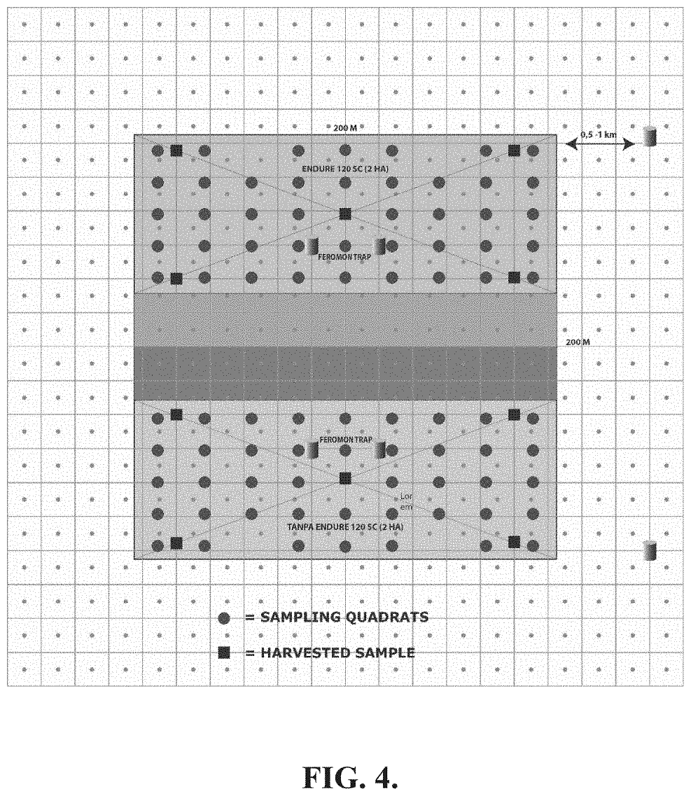

Every 3 to 4 days, the number of YSB caught in pheromone “bucket” traps deployed in each sub plot are counted. FIGS. 3-4. 2 traps are installed in the center of each sub-plot, spaced 30 meters from each other. 2 “external check” traps are installed 0.5-1 km away from the nearest experimental main plot. The external check traps are 100 m apart from each other, and within a rice field. After each trap count, captured moths are removed, and traps are inspected for damage, obstructions, and insufficient water levels. Trap lures are changed every 2 weeks.

### Results and Discussion

The effectiveness of non-natural insect pheromone blend compositions to result in Scirpophaga incertulas mating disruption in a rice cultivation area was confirmed. Exposure of S. incertulas to a single dose of the tested insect pheromone blend compositions in PheriumTM Dispenser SDS, RICE DISPENSER_Version 1_180702 sachets reduced dead-heart and whitehead symptoms within rice tillers due to infertility of eggs placed by female YSB. The use of the insect pheromone blend compositions for mating disruption reduces reproduction of the insect.

Pherium™ Rice Mylar Dispensers (Provivi™) (referred to as “ChiSu dispensers”) were set up containing low density polyethylene and Mylar foil, where the foil side was impermeable and decreases solar radiation. Dispensers were installed at transplanting, at hypothetical panicle height, for season-long control. The reservoir was equipped with a paper wick, and a 2″ flap for attachment. FIG. 2.

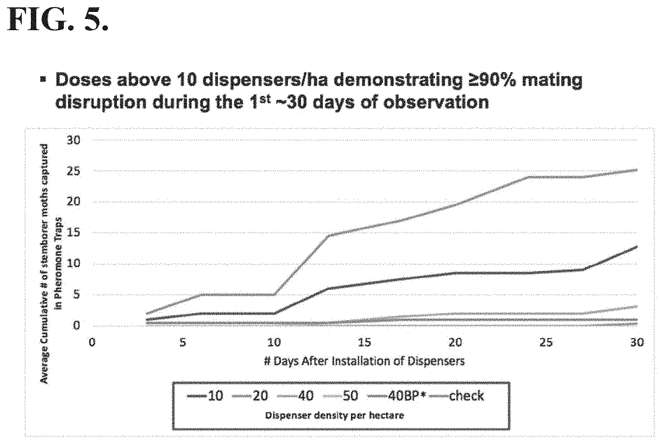

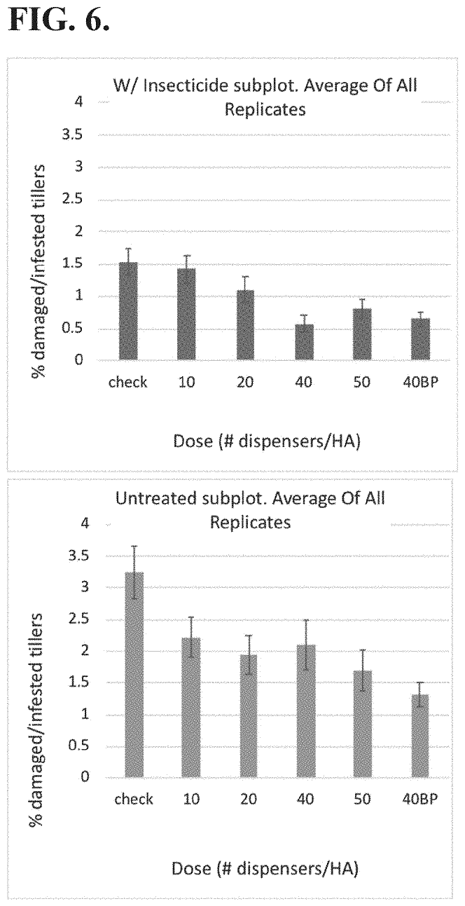

Dispensers contained either 1.25 g C. suppressalis pheromone blend (81% Z11-16Ald, 9% Z9-16Ald, 10% Z13-18A1d) per dispenser, neat A.I. w/ stabilizers, at tested coverage rates of 10, 20, 40, and 50 dispensers/ha, or a non-natural pheromone blend of Z11-16Ald, Z9-16Ald, Z13-18Ald, and Z9-18Ald in an amount between 5-12% (“40BP”) at a tested coverage rate of 40 dispensers/ha. FIGS. 5-6.

Surprisingly, it was found that the Z11-16Ald, Z9-16Ald, Z13-18Ald, and Z9-18Ald blend provided effective mating disruption. FIG. 6. In fact, the Z11-16Ald, Z9-16Ald, Z13-18Ald, and Z9-18Ald blend was found to be more effective than the conventional Z11-16Ald, Z9-16Ald, and Z13-18Ald blend in both the insecticide and no insecticides subplots. Higher pheromone doses improved damage control, with higher pheromone doses without insecticides nearing the damage levels of control plots with insecticides.

### Example 2: Scirpophaga incertulas Mating Disruption and Damage Control using a Non-Natural Pheromone Blend

It was further discovered that a non-natural insect pheromone blend composition (75% Z11-16Ald, 8% Z9-16Ald, 10% Z13-18Ald, 7% Z9-18A1d) improved the pest control of Scirpophaga incertulas in a rice cultivation area compared to a natural insect pheromone blend composition. The use of the 4-component insect pheromone blend composition for mating disruption reduced reproduction of the adult insect, and thus reduces dead-heart and whitehead symptoms within rice tillers that result from the foraging of their offspring. The addition of the Z13-18Ald and Z9-18Ald was found to exert a synergistic effect on the other components in the blend.

### Materials and Methods

Insect control experiments were performed on 9-10 hectare-sized plots at various locations using either a sachet dispenser of mating disruption pheromone, or a non-pheromone control. The plots containing the natural pheromone blend treatment were conducted in a previous year and were divided so that a sub plot of the main plot was treated with YSB insecticides (Endure™ 12 SC), while the other was left without insecticide applications. As there were no insecticides applied to the entire non-natural pheromone blend treatment plots the following year, only the non-insecticide samples were compared between treatments for the purposes of this analysis.

Pherium™ Rice Mylar Dispensers (Provivi™) were comprised of low-density polyethylene and Mylar foil, where the foil side is impermeable. Each dispenser contains 1.25 g of either a non-natural pheromone blend (75% Z11-16Ald, 8% Z9-16Ald, 10% Z13-18Ald, 7% Z9-18Ald per dispenser) at a tested coverage rate of 20 & 30 dispensers/ha, or a natural Scirpophaga incertulas pheromone blend (75% Z11-16Ald, 25% Z9-16Ald) at a tested coverage rate of 40 dispensers/ha. Dispensers were installed at transplanting, at a panicle height of 1.2 m, for season-long control. In control plots, no pheromone was applied over the entire plot. Every 3 to 7 days, the number of YSB caught in pheromone “bucket” traps deployed in each plot were counted. After each trap count, captured moths were removed, and traps were inspected for damage, obstructions, and insufficient water levels. Trap lures were changed every 2 weeks. Damage sampling differed between the two pheromone blend treatments, in terms of the position and number of sampling quadrats. Generally, however, damage was assessed every 1 or 2 weeks by counting the number of dead hearts or whiteheads (during the vegetative and generative stages respectively) within a sampling quadrat.

### Results and Discussion

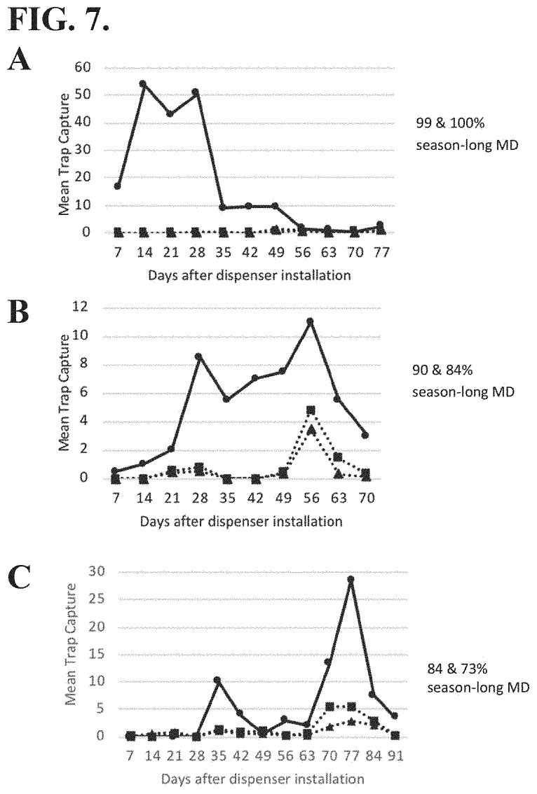

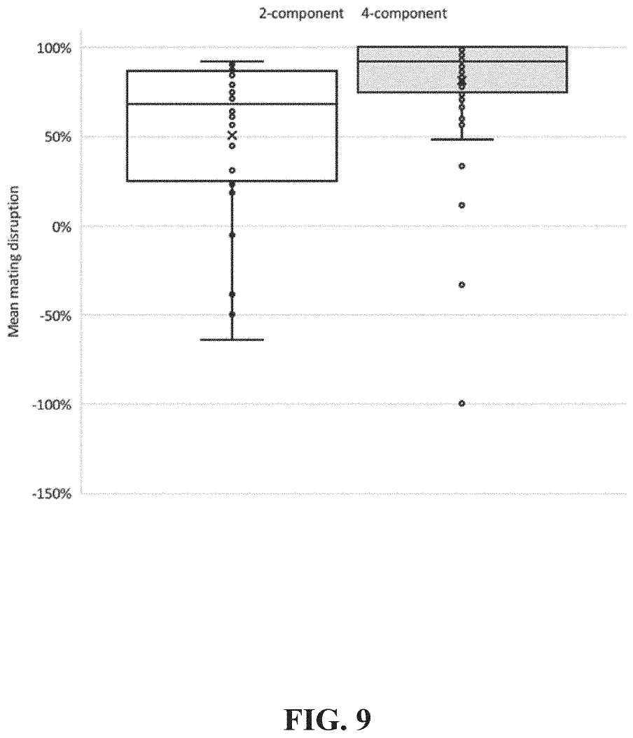

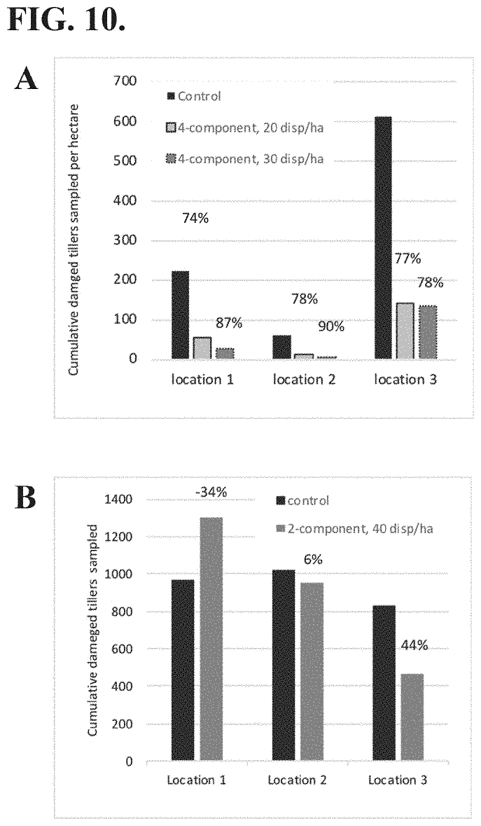

Surprisingly, it was found that the non-natural pheromone blend (Z11-16Ald, Z9-16Ald, Z13-18Ald, and Z9-18A1d) provided effective mating disruption. FIG. 7. In fact, the Z11-16Ald, Z9-16Ald, Z13-18Ald, and Z9-18Ald blend was more effective at decreasing both trap captures and damage than the conventional natural pheromone blend (Z11-16Ald and Z9-16A1d) when compared to their paired control plots. FIG. 9; FIG. 10. The addition of both Z13-18Ald and Z9-18Ald is found to exert a synergistic effect on the other components in the blend. It was also surprising that better mating disruption and damage control is achieved despite the non-natural pheromone blend treatments being applied at a lower dose (20 & 30 dispensers/ha) than the natural pheromone blend treatment (40 dispenser/ha). Stemborer damage in the non-natural pheromone blend treatments never exceeded the damage thresholds that would have triggered an insecticide application as it did in the control plots where there was an average of 3 applications throughout the season.

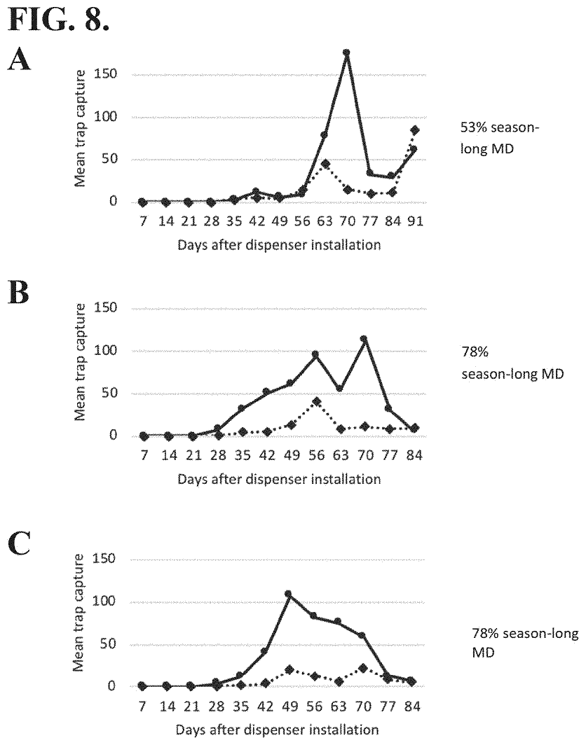

Over the entire season the 3 testing locations of the natural pheromone blend achieved, 53%, 78%, and 78% mating disruption at 40 dispenser/ha (FIG. 8), while the testing locations for the lower 20 dispenser/ha dose of the non-natural blend still achieved 99%, 90%, and 84% mating disruption (FIG. 7). On individual sampling days through the season, the non-natural pheromone blend treatment achieved consistent and higher percent mating disruption than the natural pheromone blend treatment. FIG. 9. The natural pheromone blend had mixed results pertaining to damage control depending on the testing location. FIG. 10 (−34%, 6%, 44%). Comparably, the non-natural pheromone blend treatment showed a greater improvement, with all treatments and locations exceeding 74% damage control.

1. A composition for modifying the behavior of an insect pest, the composition comprising Z11-16Ald, Z9-16Ald, Z9-18Ald, and Z13-18Ald.

2. The composition of claim 1, wherein the composition comprises Z11-16Ald, Z9-16Ald, Z13-18Ald, and Z9-18Ald in the ratio:
58-84% (Z11-16Ald) : 5%-14% (Z9-16Ald): 5-14 (Z13-18Ald) : 5-14 (Z9-18Ald).

3. The composition of claim 1, wherein the composition comprises about 74% Z11-16Ald, about 7% Z9-16Ald, about 8% Z13-18Ald, and about 11% Z9-18Ald.

4. The composition of any of claims 1-3, wherein the presence of Z9-18Ald or Z13-18Ald in the composition acts synergistically to modify the behavior of Scirpophaga incertulas insects.

5. The composition of any of claims 1-3, wherein the presence of Z9-18Ald or Z13-18Ald in the composition acts synergistically to modify the behavior of Chilo Supressalis insects.

6. The composition of any of claims 1-5, further comprising an agriculturally acceptable adjuvant or carrier, binder, fungicide, herbicide or insecticide.

7. The composition of claim 6, wherein the composition is a sprayable formulation.

8. The composition of claim 6, wherein the composition is bound to a solid substrate.

9. A method for modifying the behavior of a lepidopteran insect, the method comprising:
exposing the insect to the composition of any of claims 1-8.

10. The method according to claim 9, wherein exposing the insect to the composition comprises placing a dispenser in an environment containing host plants of the insect, wherein the dispenser releases the composition into the environment.

11. The method according to claim 9 or claim 10, wherein modifying the behavior of the insect comprises disrupting mating of the insect.

12. A means for trapping insect pests, comprising the composition of any of claims 1-8.

13. The means for trapping insect pests of claim 12, wherein the means for trapping insect pests is a dispenser or trap.

14. The means for trapping insect pests of claim 12 or 13, further comprising an insecticide effective against a lepidopteran insect.
